(19) United States
(12) Patent Application Publication
(10) Pub. No.: US 2016/0306251 A1
(43) Pub. Date: Oct. 20, 2016

(54) DRIVING DEVICE FOR ELECTROCHROMIC DEVICE, ELECTROCHROMIC APPARATUS, OPTICAL FILTER, IMAGING APPARATUS, LENS UNIT, AND WINDOW MEMBER INCLUDING ELECTROCHROMIC DEVICE, AND METHOD FOR DRIVING ELECTROCHROMIC DEVICE

(71) Applicant: Canon Kabushiki Kaisha, Tokyo (JP)

(72) Inventors: Jun YAMAMOTO, Tokyo (JP); Shinjiro OKADA, Kamakura-shi (JP); Kenji YAMADA, Yokohama-shi (JP)

(21) Appl. No.: 15/108,269

(22) PCT Filed: Dec. 10, 2014
(86) PCT No.: PCT/JP2014/083323

§ 371 Date: Jun. 24, 2016

(30) Foreign Application Priority Data
Dec. 26, 2013 (JP) 2013-269688

(51) Int. Cl. G02F 1/163

(52) U.S. Cl. CPC G02F 1/163; G02F 2001/1515

(57) ABSTRACT

The present invention provides a driving device for an electrochromic device, the driving device including a controller. An electrochromic device has a characteristic region in which a change in a Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, and the a controller controls the electrochromic device such that a Duty ratio employed in the case where the light transmittance of the electrochromic device is decreased to the intended light transmittance T₁ is different from a Duty ratio employed in the case where the light transmittance of the electrochromic device is increased to the intended light transmittance T₁.

### TECHNICAL FIELD

The present invention relates to a driving device for an electrochromic device; an electrochromic apparatus, optical filter, imaging apparatus, lens unit, and window member each including an electrochromic device; and a method for driving an electrochromic device.

### BACKGROUND ART

An electrochromic phenomenon is a phenomenon in which a reversible electrochemical reaction (oxidation reaction or reduction reaction) caused by application of voltage changes the light absorption properties of a material, such as a wavelength range of light to be absorbed, with the result that the material is colored or discolored. A device which causes electrochemical color changes on the basis of the electrochromic phenomenon is referred to as an electrochromic device, and such a device is expected to be applied to a light control device which controls light transmittance.

NPL 1 discloses a pulse width modulation (PWM) driving method as a driving method for controlling light transmittance with such an electrochromic device; in the method, a voltage that causes an electrochemical reaction in an organic electrochromic (EC) device formed of a single material is applied in the form of a pulse, and the duration of the application of voltage in one pulse period (Duty ratio) is controlled. In the driving method disclosed in NPL 1, however, a variation in absorbance due to the hysteresis of the organic electrochromic device is not considered; hence, when an increase and decrease in absorbance are aimed at the same level, the results differ between the increased absorbance and the decreased absorbance.

### CITATION LIST

### Non Patent Literature

NPL 1 “Solar Energy Materials & Solar Cells”. 2012, 104, 140-145

### SUMMARY OF INVENTION

An aspect of the present invention provides a driving device for an electrochromic device which includes a pair of electrodes and an electrochromic layer disposed between the electrodes and containing an electrochromic material, the driving device including a controller which applies a driving voltage to the electrochromic device as a continuous driving pulse having one cycle including a period of application of the driving voltage and an intermission period and which controls the absorbance of the electrochromic device by adjusting a Duty ratio which is a proportion of the period of application of the driving voltage to the one cycle, the driving voltage being a voltage which causes at least any one of an oxidation reaction and reduction reaction of the electrochromic material, wherein the electrochromic device has a characteristic region in which a change in the Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, and the controller performs the control in which a Duty ratio employed in the case where the light transmittance of the electrochromic device is decreased to the intended light transmittance T₁ in the characteristic region is different from a Duty ratio employed in the case where the light transmittance of the electrochromic device is increased to the intended light transmittance T₁.

Another aspect of the present invention provides a method for driving an electrochromic device which includes a pair of electrodes and an electrochromic layer disposed between the electrodes and containing an electrochromic material, the method including use of a controller which applies a driving voltage to the electrochromic device as a continuous driving pulse having one cycle including a period of application of the driving voltage and an intermission period and which controls the absorbance of the electrochromic device by adjusting a Duty ratio which is a proportion of the period of application of the driving voltage to the one cycle, the driving voltage being a voltage which causes at least any one of an oxidation reaction and reduction reaction of the electrochromic material, wherein the electrochromic device has a characteristic region in which a change in the Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, and the controller controls the electrochromic device such that a Duty ratio employed in the case where the light transmittance of the electrochromic device is decreased to the intended light transmittance T₁ in the characteristic region is adjusted so as to be different from a Duty ratio employed in the case where the light transmittance of the electrochromic device is increased to the intended light transmittance T₁.

Further features of the present invention will become apparent from the following description of exemplary embodiments with reference to the attached drawings.

### BRIEF DESCRIPTION OF DRAWINGS

FIG. 1 schematically illustrates an example of an electrochromic device which is driven by a driving device for an electrochromic device according to a first embodiment.

FIG. 2 schematically illustrates an example of the driving device for an electrochromic device according to the first embodiment and an example of an electrochromic device driven by the driving device.

FIG. 3A illustrates a driving pattern in an example of control of driving by the driving device for an electrochromic device according to the first embodiment.

FIG. 3B illustrates an example of driving by the driving device for an electrochromic device according to the first embodiment.

FIG. 4 schematically illustrates the relationship in a Duty ratio in the case where control is not performed by the driving device for an electrochromic device according to the first embodiment.

FIG. 5 schematically illustrates an imaging apparatus according to a third embodiment.

FIG. 6 schematically illustrates an imaging apparatus having a different structure from the imaging apparatus of the third embodiment.

FIG. 7A schematically illustrates a window member of a fourth embodiment.

FIG. 7B is a cross-sectional view illustrating the window member taken along a line VIIB-VIIB in FIG. 7A.

FIG. 8 illustrates changes in absorbance in the case where an organic electrochromic device of Example 1 is driven from the initial state in a coloring direction at predetermined Duty ratios.

FIG. 9 illustrates a change in absorbance in the case where the organic electrochromic device of Example 1 is driven from a colored state in a discoloring direction at a predetermined Duty ratio.

FIG. 10 illustrates the relationships between absorbance and a Duty ratio in the case where the organic electrochromic device of Example 1 is driven in a coloring direction and in a discoloring direction.

FIG. 11 illustrates a change in absorbance in the case where the organic electrochromic device of Example 1 is driven in consideration of the hysteresis characteristics thereof.

FIG. 12 illustrates the relationships between absorbance and a Duty ratio in the case where the organic electrochromic device of Example 2 is driven in a coloring direction and in a discoloring direction.

FIG. 13 illustrates a change in absorbance in the case where the organic electrochromic device of Example 2 is driven in consideration of the hysteresis characteristics thereof.

### DESCRIPTION OF EMBODIMENTS

Embodiments of the present invention will now be described in detail with reference to the drawings.

### First Embodiment

A driving device for an electrochromic device according to a first embodiment includes a controller which applies a driving voltage to an electrochromic device including a pair of electrodes and an electrochromic layer disposed between the electrodes and containing an electrochromic material, the driving voltage being a voltage which causes at least any one of an oxidation reaction and reduction reaction of the electrochromic material and being in the form of a continuous driving pulse having one cycle including a period of application of the driving voltage and an intermission period. The controller controls the absorbance of the electrochromic device by adjusting a Duty ratio which is a proportion of the period of application of the driving voltage to the one cycle. In the electrochromic device having a characteristic region in which a change in the Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, the controller performs the control in which a Duty ratio employed in the case where the light transmittance of the electrochromic device is decreased to the intended light transmittance T₁ is different from a Duty ratio employed in the case where the light transmittance of the electrochromic device is increased to the intended light transmittance T₁.

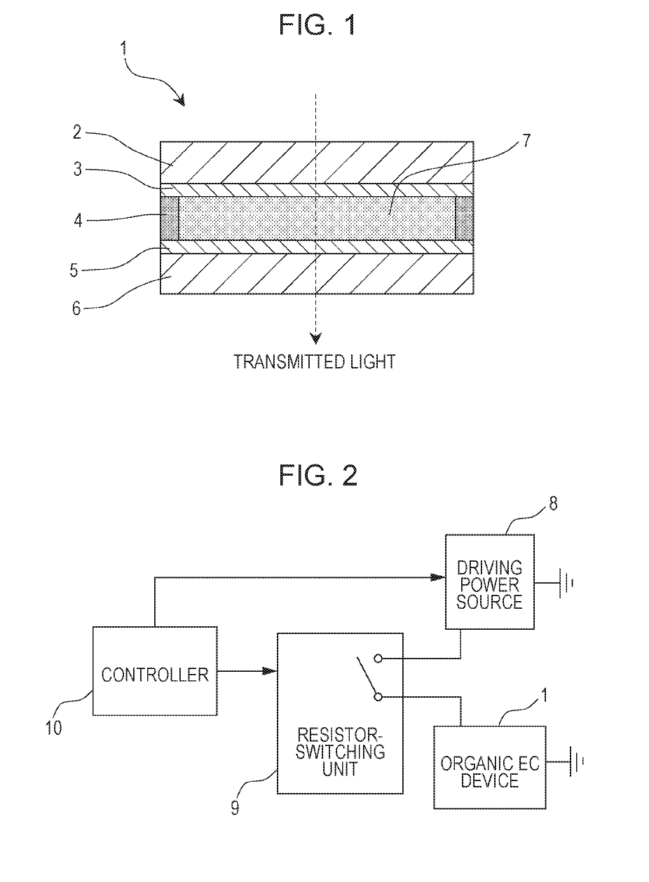

FIG. 1 schematically illustrates an organic electrochromic device (hereinafter also referred to as EC device) that is an example of an EC device which can be driven by the driving device for an EC device according to the first embodiment.

The EC device illustrated in FIG. 1 has the structure of an organic electrochromic device; in the structure, a pair of transparent electrodes 3 and 5 are disposed on a pair of transparent substrates 2 and 6, respectively; the transparent substrates 2 and 6 are arranged with a spacer 4 interposed therebetween such that the surfaces of the electrode face each other; and an EC layer 7 in which an electrolyte and an organic electrochromic material (also referred to as organic EC material) have been dissolved in a solvent is disposed in a space defined by the transparent electrodes 3 and 5 and the spacer 4.

In general, organic EC materials are in a neutral state and have no absorption in a visible light region when voltage is not applied thereto. In such a colorless state, an organic EC device has a high light transmittance. In the case where a voltage is applied between the transparent electrodes 3 and 5 from an external power source (not illustrated) connected thereto, an electrochemical reaction occurs in the organic EC material, and thus the organic EC material converts from the neutral state to an oxidation state (cation) or a reduction state (anion). Such an electrochemical reaction causes the organic EC material to be present in the form of a cation or an anion, so that the organic EC material can absorb light in a visible light region and is therefore colored. In the colored state, the organic EC device has a low light transmittance.

The materials of the transparent substrates 2 and 6 and transparent electrodes 3 and 5 can be materials which can transmit the enough amount of visible light. This is because it is desirable that an organic EC device applied to a light control device continue to have a high light transmittance in a colorless state in order to reduce an effect on an optical system.

The material of the transparent substrates 2 and 6 can be a material having a high light transmittance in a visible light region, specifically a glass material. Other materials such as plastic materials and ceramics can be employed provided that these materials have enough transparency. The transparent substrates 2 and 6 can be formed of a material which is rigid and thus less likely to be deformed. In addition, a less flexible substrate can be used.

The material of the transparent electrodes 3 and 5 can be a material having a high light transmittance in a visible light region and a high conductivity. Examples of such a material include metals and metal oxides such as indium tin oxide (ITO) alloys, tin oxide (NESA), indium zinc oxide (IZO), silver oxide, vanadium oxide, molybdenum oxide, gold, silver, platinum, copper, indium, and chromium; silicon materials such as polycrystal silicon and amorphous silicon; and carbon materials such as carbon black, graphene, graphite, and glassy carbon. In addition, conductive polymers subjected to a doping treatment or another treatment to enhance their conductivity can be employed, such as polyaniline, polypyrrole, polythiophene, polyacetylene, polyparaphenylene, and complexes of polyethylenedioxythiophene with polystyrene sulfonic acid (PEDOT:PSS). It is desirable that an organic EC device which is driven by the driving device for an EC device according to the first embodiment have a high light transmittance in a colorless state; hence, for example, ITO, IZO, NESA, PEDOT:PSS, and graphene can be particularly used. These materials can be used in various forms such as a bulky form and a particulate form. Such electrode materials can be used alone or in combination.

The EC layer 7 contains an electrolyte, an organic EC material, and a solvent.

Any solvent can be used in the EC layer 7 provided that the electrolyte can be dissolved therein, and a polar solvent can be especially employed. Specific examples of the solvent includes water and organic polar solvents such as methanol, ethanol, propylene carbonate, ethylene carbonate, dimethyl sulfoxide, dimethoxyethane, acetonitrile, γ-butyrolactone, γ-valerolactone, sulfolane, dimethylformamide, dimethoxyethane, tetrahydrofuran, propionitrile, dimethylacetamide, methylpyrrolidinone, and dioxolane.

The electrolyte is not particularly limited provided that it is an ionically dissociable salt, has a good solubility, and is a salt containing a cation or anion having electron donicity to such an extent that enables steady coloring of the organic EC material. Examples of such an electrolyte include a variety of salts of inorganic ions, such as alkali metal salts and alkaline earth metal salts; quaternary ammonium salts; and cyclic quaternary ammonium salts. Specific examples thereof include alkali metal salts of Li, Na, and K, such as LiClO4, LiSCN, LiBF4, LiAsF6, LiCF3SO3, LiPF6, LiI, NaI, NaSCN, NaClO4, NaBF4, NaAsF6, KSCN, and KCl; and quaternary ammonium salts and cyclic quaternary ammonium salts, such as (CH3)4NBF4, (C2H5)4NBF4, (n-C4H9)4NBF4, (C2H5)4NBr, (C2H5)4NClO4, and (n-C4H9)4NClO4. Furthermore, an ionic liquid can be also used. These electrolyte materials can be used alone or in combination.

The EC layer 7 can be liquid or gel. In the case where the EC layer 7 is gel, the EC layer 7 can be formed by adding a gelling agent such as a polymer to a solution containing an electrolyte and an organic EC material or by allowing a transparent and flexible material having a network structure (e.g., spongy material) to support the solution containing an electrolyte and an organic EC material.

In the case where a gelling agent such as a polymer is added to the solution containing an electrolyte and an organic EC material, examples of the gelling agent include polyacrylonitrile, carboxymethyl cellulose, polyvinyl chloride, polyvinyl bromide, polyethylene oxide, polypropylene oxide, polyurethane, polyacrylate, polymethacrylate, polyamide, polyacrylamide, polyester, polyvinylidene fluoride, and Nafion.

The organic EC material contained in the EC layer 7 may be any material provided that the material is soluble in the solvent and converts from a colored state to a colorless state or from the colorless state to the colored state by an electrochemical reaction (oxidation reaction or reduction reaction). Multiple materials can be used in combination.

The organic EC material may be a single anodic material which is oxidized to enter a colored state or may be a combination of different anodic materials. The organic EC material may be a single cathodic material which is reduced to enter a colored state or may be a combination of different cathodic materials. An anodic material and a cathodic material may be used in combination. Anodic materials and cathodic materials may be used in combination. The term “different materials” herein refers to multiple materials having different chemical structures, and the term “being different” refers to “having different chemical structures”.

Specific examples of the organic EC material include organic dyes such as a viologen dye, a styryl dye, a fluoran dye, a cyanine dye, and an aromatic amine dye and organic metal complexes such as a metal-bipyridyl complex and a metal-phthalocyanine complex. The viologen dye which is in a colorless state when it is in the form of a stable dication with counter ions and which enters a colored state when it becomes a cation through a one-electron reduction reaction can be used as a cathodic material.

In particular, it is preferred that a compound which has an electrochromic moiety having at least one thiophene ring be used as an anodic organic EC material. It is more preferred that the anodic organic EC material be a compound which has an electrochromic moiety having at least one thiophene ring and two aromatic rings directly bonded to the electrochromic moiety, in which the atoms of the two aromatic rings that are adjacent to the atoms bonded to the electrochromic moiety are substituted with an alkyl group, an alkoxy group, or an aryl group, and in which the atoms of the electrochromic moiety that are adjacent to the atoms bonded to the two aromatic rings are substituted with an alkyl group, an alkoxy group, or an aryl group.

An example of such a compound which has an electrochromic moiety having at least one thiophene ring is a compound having the following structure represented by General Formula (1).

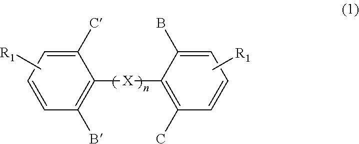

In General Formula (1), B, B′, C, and C′ are each independently selected from an alkyl group having 1 to 20 carbon atoms, an alkoxy group having 1 to 20 carbon atoms, and an optionally substituted aryl group. R₁ represents a hydrogen atom or a substituent group. n is an integer from 1 to 5.

X represents a structure represented by General Formula (2), (3), (4), or (5); in the case where n is 2 or more, multiple X moieties are each independently selected from structures represented by Formulae (2), (3), (4), and (5).

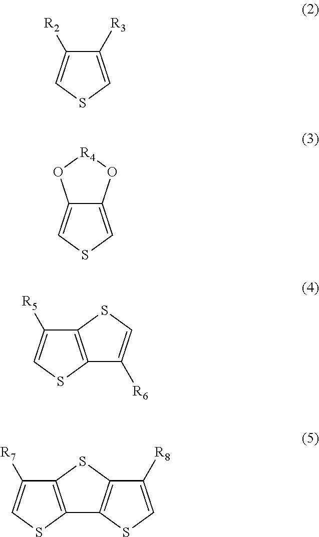

In General Formulae (2), (3), (4), and (5), R₂ and R₃ are each independently selected from a hydrogen atom, an alkyl group having 1 to 20 carbon atoms, an alkoxy group having 1 to 20 carbon atom, an optionally substituted aryl group, and an alkyl ester group having 1 to 20 carbon atoms. R₄ is an alkylene group having 1 to 20 carbon atoms. R₅ to R₈ are each independently selected from an alkyl group having 1 to 20 carbon atoms, an alkoxy group having 1 to 20 carbon atoms, an optionally substituted aryl group, and an alkyl ester group having 1 to 20 carbon atoms.

In General Formula (1), in the case where the thiophene ring bonded to the aromatic rings is represented by General Formula (2), R₂ and R₃ are not hydrogen atoms but substituent groups.

Specific examples of the compound which has the electrochromic moiety having at least one thiophene ring include the following compounds.

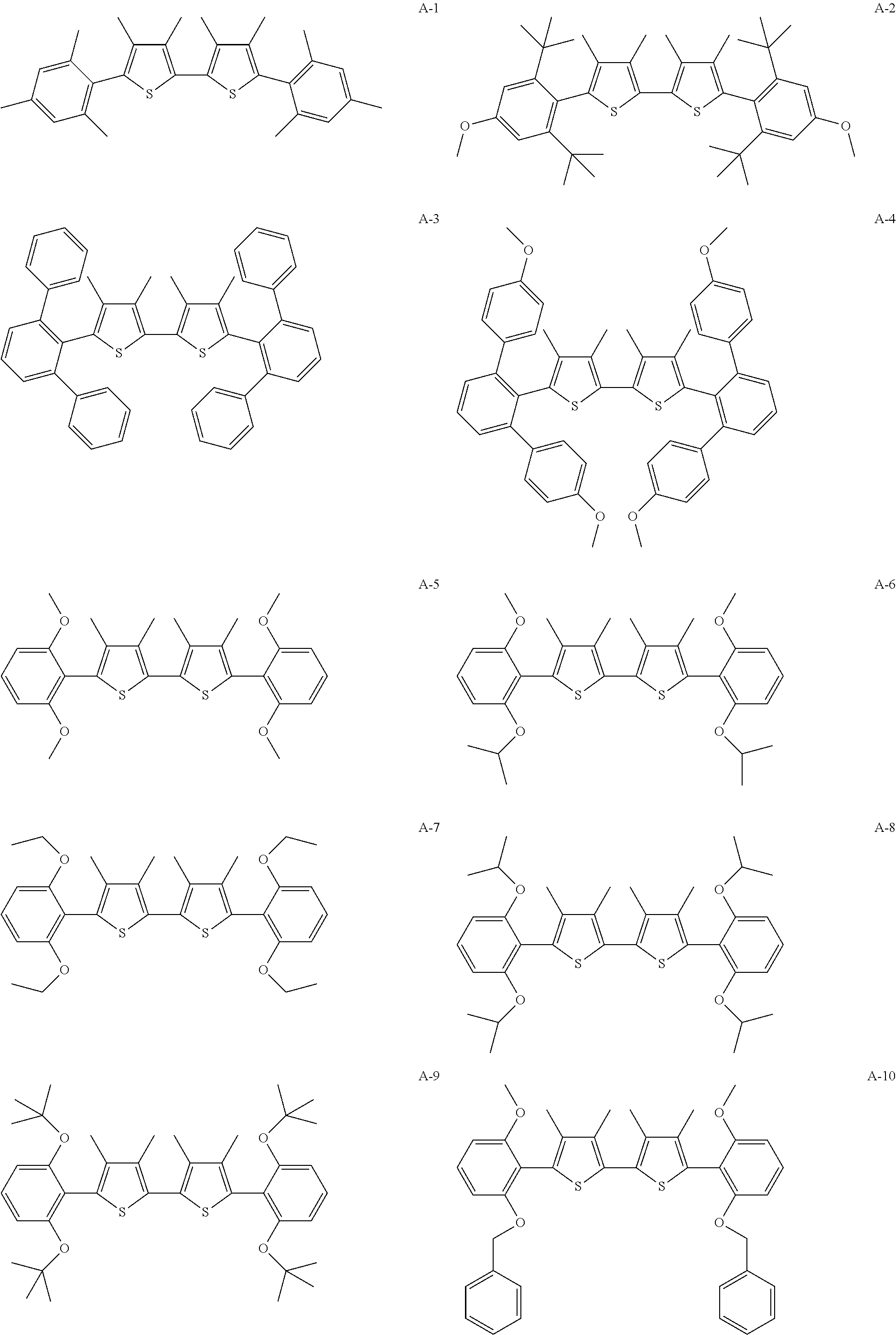

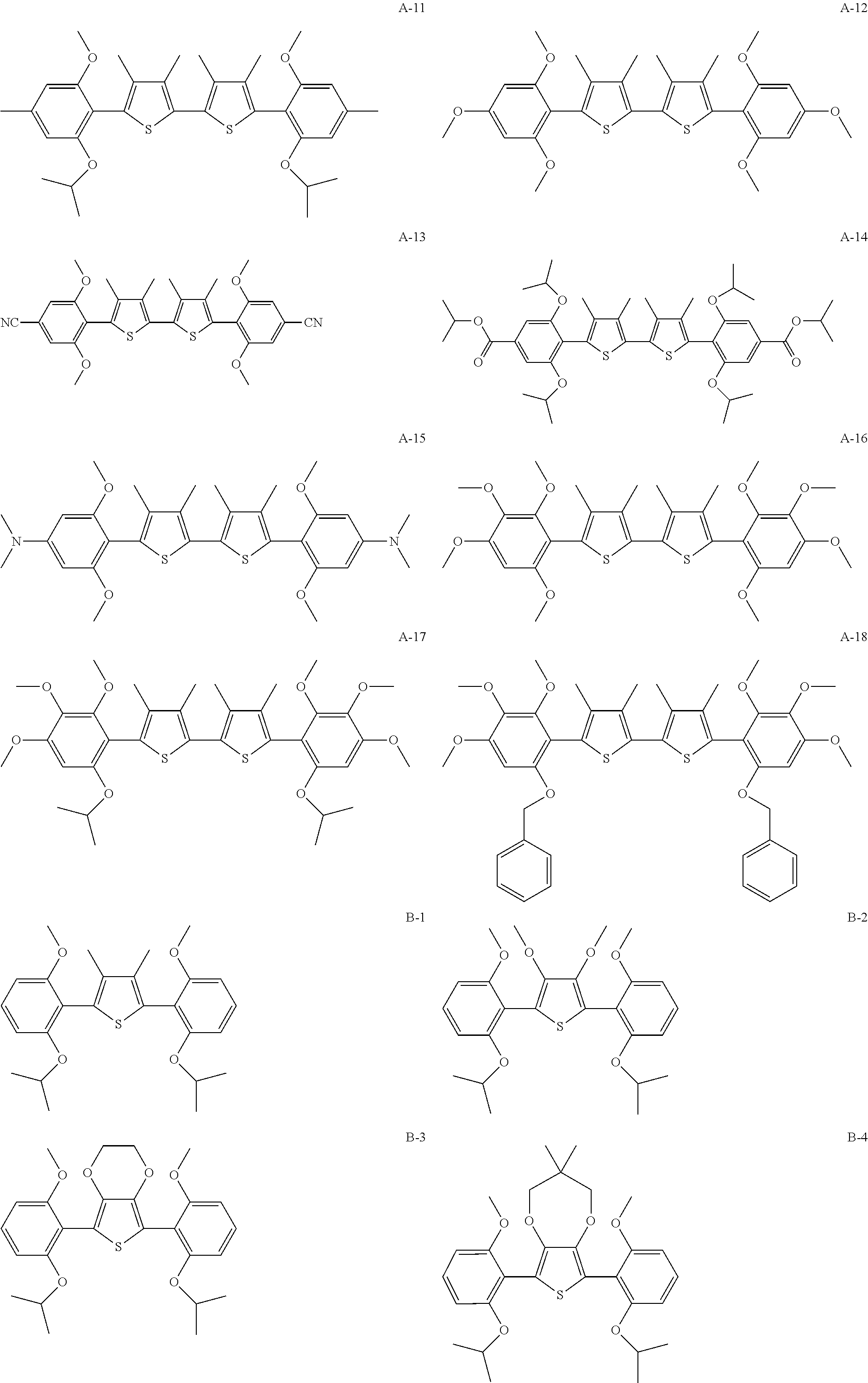

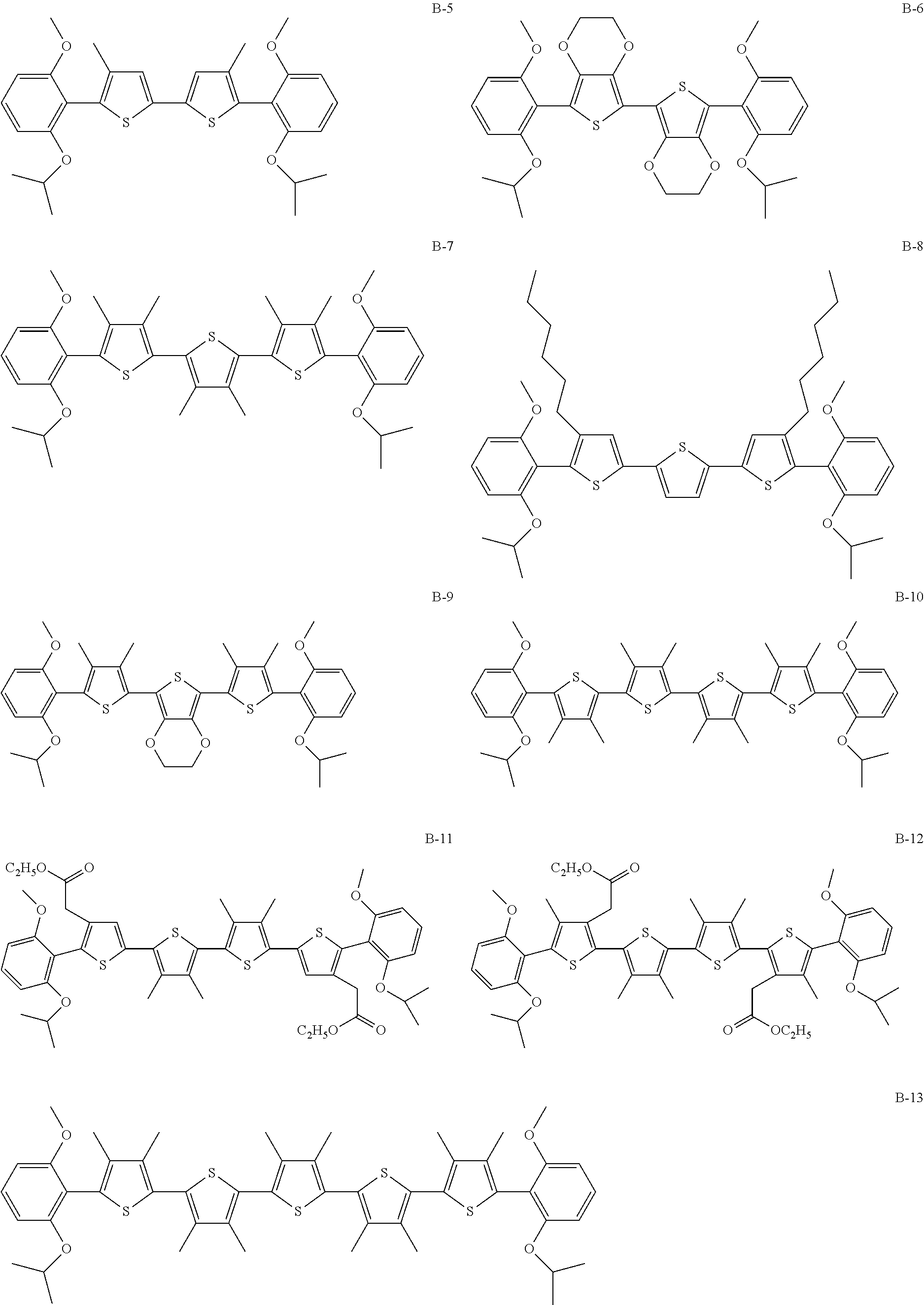

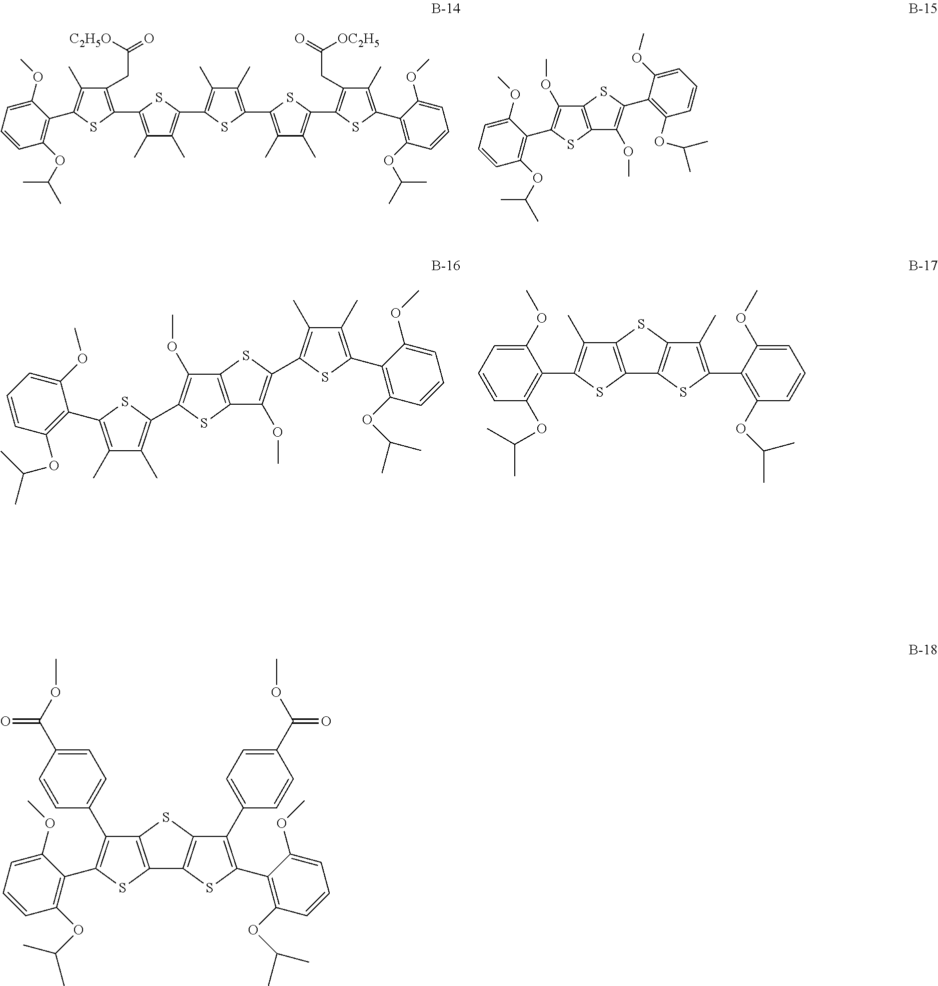

Among these exemplified compounds, the compounds assigned reference symbols starting from A are each an example of a compound having an electrochromic moiety [moiety represented by X in General Formula (1)] which is a dimer of 3,4-dimethylthiophene and having the molecular terminals which are aromatic rings having various substituent groups [B, B′, C, C′, and R₁ in General Formula (1)]. The compounds assigned reference symbols starting from B are each an example of a compound which has the molecular terminals that are aromatic rings having a methoxy group and an isopropoxy group as substituent groups and which has a structure of thiophene derivative that has various electrochromic properties.

Since the molecules of these exemplified compounds are less likely to associate with each other, the shapes of absorption spectra in the colored state of the EC device and in the colorless state thereof are maintained so as to be substantially similar to each other. Hence, the shape of the absorption spectrum is not greatly collapsed, and a variation in hysteresis dependence is less likely to be generated in each wavelength. Thus, such compounds enable the driving device for an EC device according to the first embodiment to be further precisely control absorbance and can be therefore employed.

The phrase “the shapes of absorption spectra in the colored state of the EC device and in the colorless state thereof are maintained so as to be substantially similar to each other” refers to the following: among all absorption peaks in which the absorbance of the wavelength having the largest absorbance is 0.3 or more, assuming that the absorbance of the wavelength having the maximum absorbance at a certain time is A, that the absorbance of the wavelength having the second maximum absorbance is B, and that an absorbance ratio A/B is defined as 1, A/B at a predetermined time is preferably in the range of 0.5 to 1.5, and more preferably 0.9 to 1.1 in each of the colored state and the colorless state.

Owing to such an absorbance ratio, absorption by black is less likely to be broken in the case where a driving device for an EC device according to the first embodiment is used to form a neutral density (ND) filter. The cause of this phenomenon is as follows.

In a neutral density filter, light is absorbed by black, and uniform absorption in the whole visible light region is therefore needed. Since an organic EC material has an absorption peak in a visible light region, EC materials having different peak absorption wavelengths are suitably mixed with each other for absorbing light by black, so that combination of absorptions of the EC materials enables light to be absorbed by black.

If the mixed EC materials include a material of which the molecules associate with each other, the shape of an absorption spectrum of such a material changes both in a coloring direction and in a discoloring direction. Hence, the intended absorption by black in the coloring direction may be different from that in the discoloring direction, and such a case is inadequate for an ND filter. In the case where all of the mixed EC materials are materials of which the molecules do not associate with each other and where the normalized absorbance ratio is in the range of 0.9 to 1.1 both in the coloring direction and in the discoloring direction, the shapes of the absorption spectra of the EC materials substantially do not change both in the coloring direction and in the discoloring direction. Thus, the intended absorption by black, which results from combination of these absorption spectra, is less likely to be broken.

Not only such a compound which has an electrochromic moiety having at least one thiophene ring but also a pyrazine material, such as phenazine, and an aromatic amine material, such as triphenylamine, can be suitably used. Although the EC layer 7 has been described as a layer containing the organic EC material, the EC layer of an EC device driven by the driving device for an EC device according to the first embodiment may contain an inorganic EC material. In such a case, for instance, a liquid in which an inorganic EC material has been dispersed in a solvent can be used for the EC layer. Examples of the inorganic EC material include tungsten oxide, vanadium oxide, molybdenum oxide, iridium oxide, nickel oxide, manganese oxide, and titanium oxide.

FIG. 2 schematically illustrates an example of the driving device for an EC device according to the first embodiment and an example of an EC device driven by the driving device. The driving device for an EC device according to the first embodiment includes a driving power source 8, a resistor-switching unit 9, and a controller 10.

A driving voltage V1 necessary to cause the electrochemical reaction of the EC material contained in the EC layer is applied from the driving power source 8 to the EC device.

The driving voltage V1 can be a fixed voltage. A fixed voltage can be employed because an absorption spectrum may change owing to differences in redox potential and in a molar absorption coefficient between different materials contained in the EC material.

The controller 10 transmits signals to start application of voltage by the driving power source 8 or to maintain a voltage-applied state, and a state in which a fixed voltage has been applied is maintained during a term in which the light transmittance of the EC device is controlled.

The resistor-switching unit 9 selects a resistor R1 or a resistor R2 having a larger resistance than the resistor R1 in a closed circuit including the driving power source 8 and the EC device to establish a series connection. The resistance value of the resistor R1 can be at least smaller than the largest impedance of the closed circuit element; in particular, the resistance value can be not more than 10Ω. The resistance value of the resistor R2 can be larger than the largest impedance of the closed circuit element; in particular, the resistance value can be not less than 1 MΩ. The resistor R2 may be air. This closed circuit can be considered as an open circuit in a strict sense; however, regarding air as the resistor R2 enables the circuit to be deemed as the closed circuit.

The controller 10 transmits switching signals to the resistor-switching unit 9 to control the switching of the resistors R1 and R2.

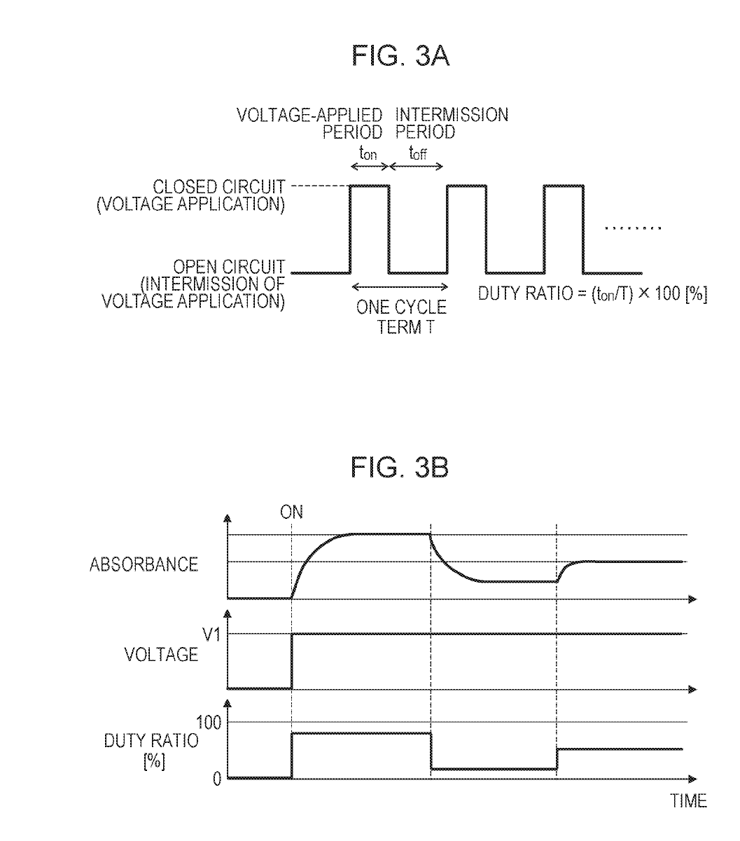

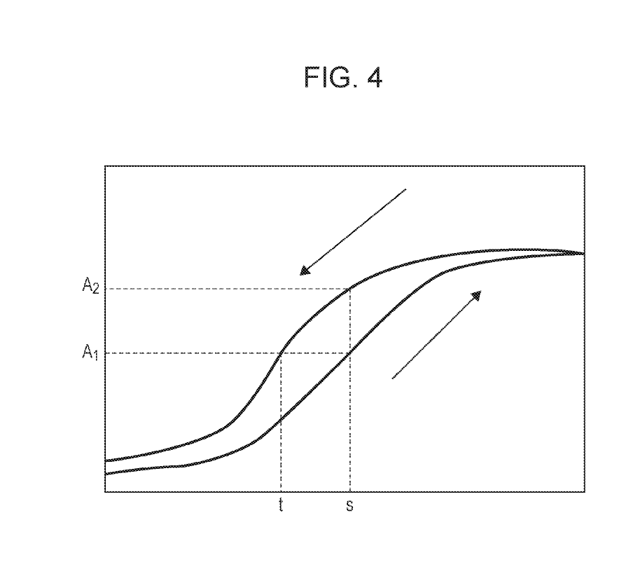

FIGS. 3A and 3B illustrate an example of control of driving by the driving device for an EC device according to the first embodiment; in particular, FIG. 3A illustrates a driving pattern, and FIG. 3B illustrates an example of the driving.

In FIGS. 3A and 3B, a fixed voltage V1 that causes an electrochemical reaction in the EC layer is applied from the driving power source 8 to the EC device 1 at a driving start point t=ON. The resistor-switching unit 9 receives signals transmitted from the controller 10 and selects the resistor R1 or R2 to establish the closed circuit including the EC device 1 and the driving power source 8. In the case where the resistor R2 is air, the resistor-switching unit 9 selects connection or disconnection in a state in which the fixed voltage V1 has been applied. In other words, the resistor-switching unit 9 operates to change the status between the state of a closed circuit and the state of an open circuit. In the state of the closed circuit, a voltage has been applied; in the state of the open circuit, a resistor having a high resistance (air) has been inserted into the power source in series. In the following description, the state of the open circuit is referred to as an intermission state, and the period thereof is referred to as an intermission period; however, the intermission state herein includes not only the state of the open circuit in which a resistor having a high resistance has been inserted into the power source in series under application of the fixed voltage V1 but also a state in which voltage is not applied, and the intermission period includes not only the period of the state of the open circuit in which a resistor having a high resistance value has been inserted into the power source in series under application of the fixed voltage V1 but also the period of a state in which voltage is not applied.

The controller 10 controls selection of a voltage-applied state or intermission state and transmits a continuous pulse to the resistor-switching unit 9; in the continuous pulse, combination of a voltage-applied period tₒₙ and an intermission period t_{off} is one cycle (term T). The proportion of the voltage-applied period to one cycle is defined as a Duty ratio.

In the case where a Duty ratio in the pulse driving is maintained, an EC material is colored in the voltage-applied period tₒₙ, and the EC material is discolored by itself in intermission period t_{off}. The self-discoloration is attributed to instability of the cation or anion of the EC material which is generated by an electrochemical reaction or to diffusion of the cation or anion to a counter electrode having an opposite potential. Absorbance is maintained at a point at which the degree of the coloration is balanced with the degree of the self-discoloration. In the case where the EC device is driven at a fixed Duty ratio under application of a fixed voltage from the driving power source 8, as illustrated in FIG. 3B, absorbance changes through a transient state, then is saturated, and is subsequently maintained. In this case, since the degree of a change in the absorbance may be visually recognized when one cycle of the control signal is long, the one cycle is preferably not more than 100 milliseconds, and more preferably not more than 10 milliseconds.

FIG. 4 schematically illustrates the relationship between absorbance and a Duty ratio in a state in which the absorbance has been saturated.

In an EC device driven by the driving device for an EC device according to the first embodiment, adjusting a Duty ratio to be smaller than the Duty ratio in the previous cycle decreases absorbance, and adjusting a Duty ratio to be larger than the Duty ratio in the previous cycle increases absorbance.

An EC device driven by the driving device for an EC device according to the first embodiment has a characteristic region in which a change in a Duty ratio for driving the EC device from a to b causes a change in the light transmittance of the EC device from T_{A} to T_{B} and in which a change in the Duty ratio from b to a causes a change in the light transmittance of the EC device from T_{C} different from T_{B} to T_{D} different from T_{A}. The term “characteristic region” herein refers to a region in a plot that shows the relationship between a Duty ratio and light transmittance, and the phrase “an EC device has a characteristic region in which a change in a Duty ratio from a to b causes a change in the light transmittance of the EC device from T_{A} to T_{B} and in which a change in the Duty ratio from b to a causes a change in the light transmittance of the EC device from T_{C} different from T_{B} to T_{D} different from T_{A}” refers to an EC device having the following property: in the case where a plot which shows the relationship between a Duty ratio and light transmittance in driving of an EC device is formed, the plot has a characteristic region in which a change in a Duty ratio from a to b causes a change in light transmittance from T_{A} to TB and in which a change in the Duty ratio from b to a causes a change in light transmittance from T_{C} different from T_{B} to T_{D} different from T_{A}.

As illustrated in FIG. 4, an EC device driven by the driving unit for an EC device according to the first embodiment has a hysteresis between the case in which absorbance is increased as a result of coloring of the EC layer of the EC device (coloring direction) and the case in which absorbance is decreased as a result of discoloring of the EC layer of the EC device (discoloring direction). Absorbance and light transmittance are in the relationship (absorbance)=−LOG(light transmittance); and the larger the absorbance is, the smaller the light transmittance is.

Such a hysteresis is caused generally in EC materials used in the EC layer of an EC device; for example, the hysteresis is often caused in the case where the molecules of EC materials associate with each other for coloring.

In FIG. 4, in the case where a Duty ratio that enables the intended absorbance A₁ in the coloring direction in which absorbance is increased is s and where the Duty ratio s is also employed in the discoloring direction in which absorbance is decreased, the resulting absorbance in the discoloring direction becomes A₂ that is larger than the intended absorbance A₁. Even when the absorbance A₁ is aimed at also in the discoloring direction, a difference in absorbance A₂−A₁ is generated between the coloring direction and the discoloring direction.

Hence, a Duty ratio in the discoloring direction is adjusted to be t that is smaller than s, and then the absorbance can be the same, namely absorbance A₁, both in the coloring direction and in the discoloring direction. The Duty ratio t can be determined by preliminarily defining relational expressions (characteristic tables) that show the relationship between a Duty ratio and absorbance both in the coloring direction and in the discoloring direction.

Taking the hysteresis characteristics between absorbance and a Duty ratio into consideration in this way enables absorbance (light transmittance) to be precisely controlled; in particular, in an EC device in which a material of which the molecules do not associate with each other is used, the absorbance (light transmittance) can be further precisely controlled in a state in which the shape of an absorption spectrum is maintained.

In the entire range of a plot that shows the relationship between a Duty ratio and light transmittance, in the case where a change in a Duty ratio from a to b causes a change in the light transmittance of the EC device from T_{A} to T_{A} and where a change in the Duty ratio from b to a causes a change in the light transmittance of the EC device from T_{C} different from T_{B} to T_{D} different from T_{A}, the intended light transmittance T₁ may be any of these light transmittances. Such a change may be shown only in part of the plot that shows the relationship between a Duty ratio and light transmittance, and the other part may not show this change (in other words, a change in a Duty ratio from x to y causes a change in a light transmittance from Tₓ to T_{y}, and a change in the Duty ratio from y to x causes a change in a light transmittance from T_{y} to Tₓ). In such a case, the control by the driving device of the first embodiment may be carried out in the above-mentioned characteristic region.

In the above description, the eventual absorbance is higher in the discoloring direction than in a coloring direction at the same Duty ratio; however, even when the absorbance is higher in the coloring direction than in a discoloring direction, the difference in the absorbance can be reduced by similar control.

Use of an EC material of which the molecules do not associate with each other in the EC layer enables the shapes of absorption spectra in the colored state of the EC device and in the colorless state thereof to be maintained so as to be substantially similar to each other, and hysteresis dependence in each wavelength is therefore reduced. Hence, a variation in a hysteresis between the coloring direction and the discoloring direction in each wavelength can be reduced in driving by the driving device for an EC device according to the first embodiment, which further reduces a difference in absorbance (the shape of an absorption spectrum can be further well maintained).

Examples of such an EC material of which the molecules do not associate with each other have been described above as examples of the EC material.

A method for driving an EC device with the driving device for an EC device according to the first embodiment enables absorbance (light transmittance) to be precisely controlled in a state in which the shape of the absorption spectrum of the EC layer is maintained.

### Second Embodiment

An optical filter of a second embodiment includes the driving device for an EC device according to the first embodiment and an EC device driven by this driving device.

The driving device has the same structure as the first embodiment except that the driving device is used in combination with an EC device to form an optical filter.

An example of the optical filter is a neutral density (ND) filter.

In a neutral density filter, light is absorbed by black, and uniform absorption in the whole visible light region is therefore needed. Since an organic EC material has an absorption peak in a visible light region, EC materials having different peak absorption wavelengths are suitably mixed with each other for absorbing light by black, so that combination of absorptions of the EC materials enables light to be absorbed by black.

An example of driving of an ND filter will now be described. In general, an ND filter adjusts the amount of light to be ½ⁿ (n is an integer) thereof. In the case of ½, light transmittance is changed from 100% to 50%; and in the case of ¼, light transmittance is changed from 100% to 25%. In the case where light transmittance is adjusted to be ½ thereof, the degree of an absorbance change is 0.3 from the relationship−LOG(light transmittance)=(absorbance); similarly, in the case where light transmittance is adjusted to be ¼ thereof, the degree of an absorbance change is 0.6.

Hence, for instance, in order to adjust the amount of light to be from ½ to 1/64 thereof, the degree of an absorbance change may be controlled to be from 0.3 to 1.8 by 0.3.

In the case where the optical filter of the second embodiment is an ND filter, a material of which the molecules do not associate with each other can be employed as an EC material used in the EC device. This is because of the following reason: if a mixed EC materials include a material of which the molecules associate with each other, the shape of an absorption spectrum of such a material changes both in a coloring direction and in a discoloring direction, the intended absorption by black in the coloring direction therefore differs from that in the discoloring direction, and such a case is inadequate for an ND filter. In the case where all of the mixed EC materials are materials of which the molecules do not associate with each other, the shapes of the absorption spectra of the EC materials do not change both in the coloring direction and in the discoloring direction. Thus, the intended absorption by black, which results from combination of these absorption spectra, is less likely to be broken.

The optical filter including an organic EC device and the driving device for controlling the organic EC device enables light transmittance to be precisely controlled as described above. In the case where the optical filter including an organic EC device is used as a light control member as described in the second embodiment, the amount of light to be controlled can be appropriately changed with one filter, which gives advantages such as a reduction in the number of members and space saving.

### Third Embodiment

An imaging apparatus of a third embodiment includes a lens unit and an imaging unit. An optical filter used in the lens unit is the optical filter of the second embodiment.

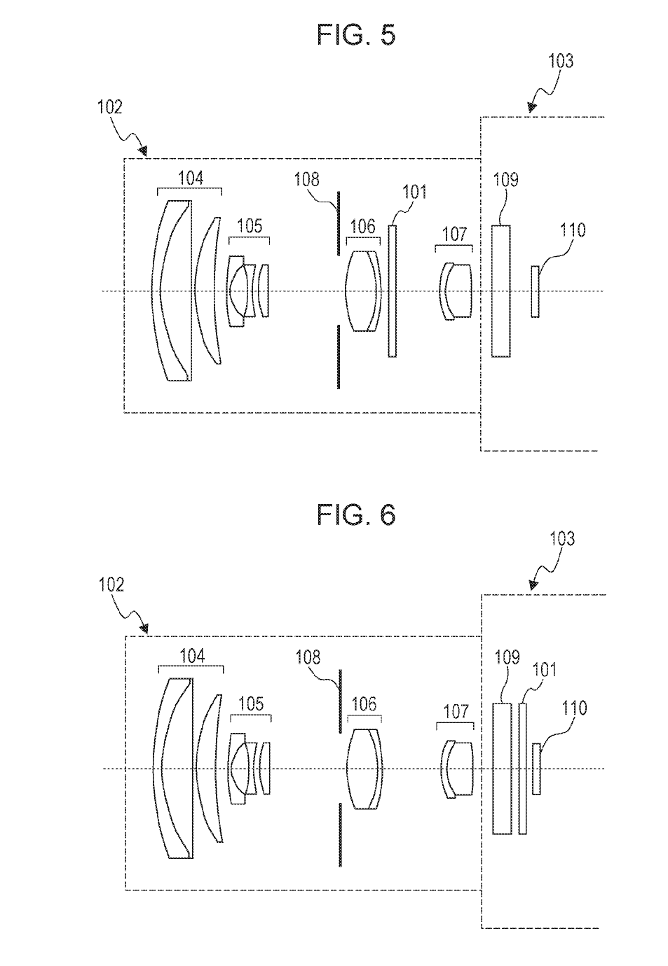

FIG. 5 schematically illustrates the imaging apparatus of the third embodiment.

The imaging apparatus of the third embodiment includes a lens unit 102 and an imaging unit 103, and the lens unit 102 is removably attached to the imaging unit 103 with a mounting member (not illustrated) interposed therebetween.

The lens unit 102 is a unit having multiple lenses or a group of lenses and is a rear-focus zoom lens in which focusing is performed in the rear of a diaphragm.

The lens unit 102 includes four lens groups including, in sequence from the object side, a first lens group 104 of positive refractive power, a second lens group 105 of negative refractive power, a third lens group 106 of positive refractive power, and a fourth lens group 107 of positive refractive power; an aperture diaphragm 108 disposed between the second lens group 105 and the third lens group 106; and an optical filter 101 disposed between the third lens group 106 and the fourth lens group 107. The distance between the second lens group 105 and the third lens group 106 is adjusted to change magnification, and then some lenses of the fourth lens group 107 are moved to perform focusing. Each component is disposed such that light to pass through the lens unit 102 passes through the first to fourth lens groups 104 to 107, the aperture diaphragm 108, and the optical filter 101. The aperture diaphragm 108 and the optical filter 101 can be used to adjust the amount of light.

The imaging unit 103 includes a glass block 109 and a light-receiving device 110.

The glass block 109 is a glass block such as a low-pass filter, a faceplate, or a color filter.

The light-receiving device 110 is a sensor which receives light that has passed through the lens unit 102 and can be an imaging device such as a charge-coupled device (CCD) or a complementary metal-oxide-semiconductor (CMOS) device. The light-receiving device 110 may be an optical sensor such as a photodiode, and a device which can obtain and output the information of light intensity or wavelength can be appropriately used.

In the imaging apparatus of the third embodiment, although the optical filter 101 according to the second embodiment is disposed between the third lens group 106 and the fourth lens group 107 in the optical lens unit 102, the position of the optical filter 101 is not limited thereto in the imaging apparatus of the present invention. The optical filter 101 may be disposed either in front of or in the rear of the aperture diaphragm 108, either in front of or in the rear of any of the first to fourth lens groups 104 to 107, or between lens groups. Placing the optical filter 101 at a position at which light converges provides a benefit such as a reduction in the size of the optical filter. In the imaging apparatus of the present invention, the type of the lens unit can be appropriately selected; an inner-focus type in which focusing is performed in front of the diaphragm and any other type may be employed as well as a rear-focus type. Not only a zoom lens but also a special-purpose lens such as a fisheye lens or a macro lens can be appropriately selected.

In the imaging apparatus of the third embodiment, the optical filter 101 according to the second embodiment is disposed inside the lens unit 102; however, in the imaging apparatus of the present invention, the EC device included in the optical filter of the second embodiment may be disposed inside the lens unit, and the driving device for the EC device may be disposed outside the lens unit, namely, in the imaging unit. In such a case, the EC device inside the lens unit is connected to the driving device for the EC device via wiring, thereby controlling the driving of the EC device.

Furthermore, in the imaging apparatus of the present invention, the optical filter 101 according to the second embodiment may be disposed inside the imaging unit 103.

FIG. 6 schematically illustrates an imaging apparatus in which the optical filter 101 according to the second embodiment is disposed inside the imaging unit 103.

The optical filter 101 is disposed between the glass block 109 and the light-receiving device 110 inside the imaging unit 103. In the case where the imaging unit 103 itself has the optical filter 101 thereinside, the lens unit 102 connected to the imaging unit 103 need not to have an optical filter, so that an imaging apparatus in which an existing lens unit can be used for light control can be provided.

In FIG. 6, although the optical filter 101 is disposed between the light-receiving device 110 and the glass block 109, arrangement of the optical filter 101 is not limited provided that the light-receiving device 110 can receive light that has passed through the optical filter 101; the optical filter 101 may be disposed at any position other than the position between the light-receiving device 110 and the glass block 109.

Such an imaging apparatus can be a product having a combination of a member for adjusting the amount of light and a light-receiving device, and examples thereof include imaging portions of cameras, digital cameras, video cameras, digital video cameras, mobile phones, smartphones, personal computers, and tablets. In the third embodiment, a rear-focus zoom lens in which focusing is performed in the rear of a diaphragm is employed.

### Fourth Embodiment

A light control window of a fourth embodiment includes an optical filter that is a window member, a transparent plate, and a frame.

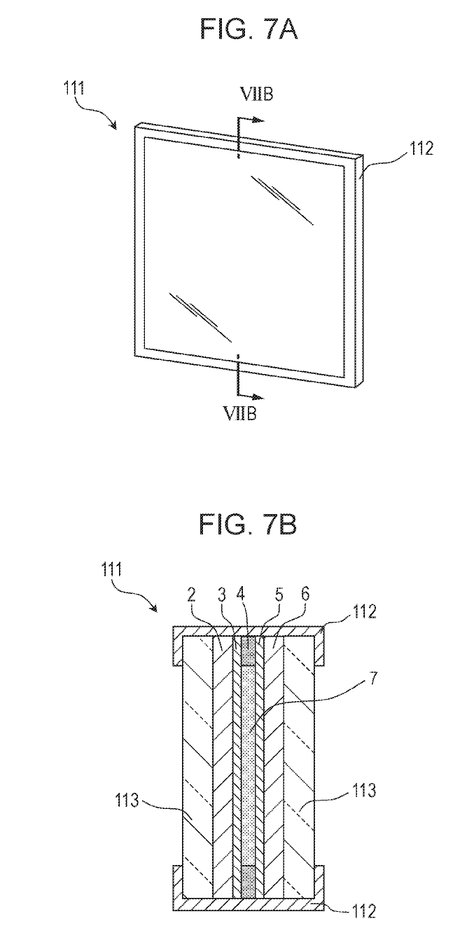

FIGS. 7A and 7B are each a conceptual diagram illustrating the light control window of the fourth embodiment.

FIG. 7A is a schematic view illustrating the light control window of the fourth embodiment, and FIG. 7B is a cross-sectional view illustrating the light control window taken along a line VIIB-VIIB in FIG. 7A. In FIG. 7B, the same symbols as in FIG. 1 represent the corresponding components.

A light control window 111 includes an optical filer that is a window member, and transparent plates 113 between which the optical filter is disposed, and a frame 112 which surrounds the optical filer and the transparent plates 113 to integrally hold them. The optical filter is the optical filter of the second embodiment, the organic EC device used in the optical filter is illustrated in FIG. 1, and the driving unit is not illustrated.

Any material having a high light transmittance can be used as the transparent plates 113; in view of application to a window, a glass material can be employed.

The light control window 111 of the fourth embodiment can be used for, for instance, adjusting the amount of sunlight that enters a room in the daytime. The light control window 111 can be applied to adjustment of the quantity of heat as well as the amount of sunlight and can be therefore used for controlling brightness and temperature in a room; for example, the light control window 111 can be applied to glass windows of buildings and windows of automobiles, trains, airplanes, and ships. Furthermore, the light control window 111 can be applied to a shutter that prevents the inside of a room from being seen from the outside.

In the light control window 111 of the fourth embodiment, the transparent plates 113 is provided aside from the transparent substrates 2 and 6 included in the organic EC device; however, the optical window 111 of the fourth embodiment may have a structure in which the transparent plates 113 are not used and in which the transparent substrates 2 and 6 serve also as the transparent plates.

In the optical window 111 of the fourth embodiment, the driving device is disposed inside the optical filter of the light control window 111; however, in the light control window of the fourth embodiment, the driving device may be integrally provided inside the frame 112 or may be disposed outside the frame 112 and connected to the organic EC device via wiring.

### Fifth Embodiment

An electrochromic apparatus of a fifth embodiment includes the driving device for an EC device according to the first embodiment and an EC device driven by this driving device. An example of such an electrochromic apparatus is a display apparatus.

### EXAMPLES

The present invention will now be described in detail with reference to Examples.

### Example 1

In Example 1, an anodic material colored by being converted from a neutral species to a cation through an oxidation reaction was used as an example of an organic EC material to explain control of light transmittance. The following compound 1 was used.

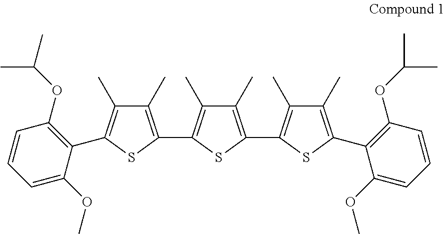 [SMILES: COc1cccc(OC(C)C)c1-c1sc(-c2sc(-c3sc(-c4c(OC)cccc4OC(C)C)c(C)c3C)c(C)c2C)c(C)c1C]

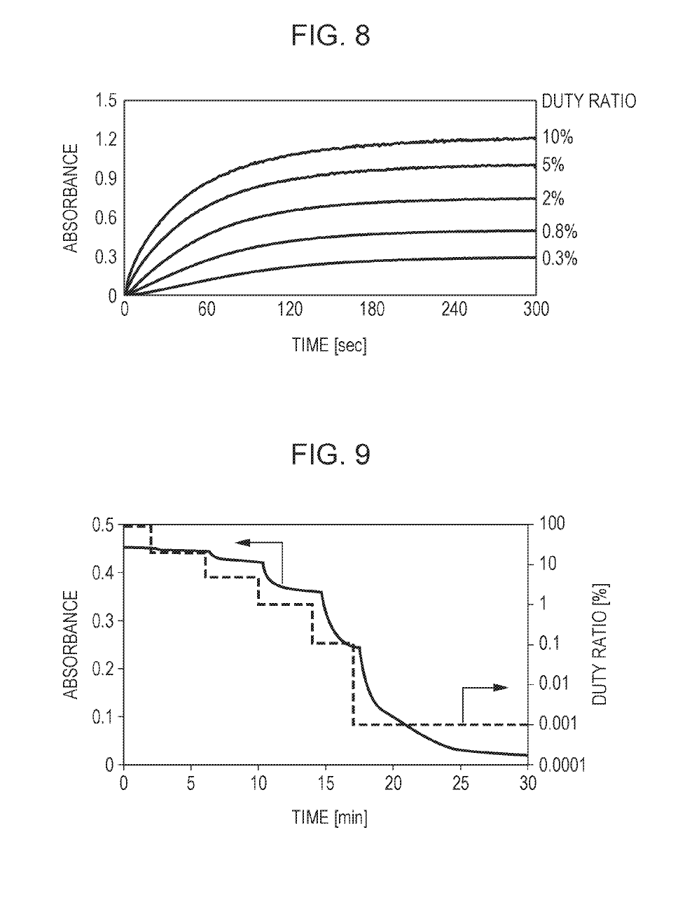

FIG. 8 illustrates changes in absorbance in an organic EC device using the compound 1 and driven from the initial colorless state in a coloring direction at fixed Duty ratios.

In the organic EC device, a solution in which the compound 1 and a supporting electrolyte (TBAP) had been dissolved in a solvent of propylene carbonate was used. The concentration of the compound 1 was 10 mM, and the concentration of TBAP was 0.1 M. The organic EC device included two FTO glass substrates attached to each other with a 125-μm thick spacer interposed therebetween, and the solution was confined in a space defined by the substrates and the spacer. A porous film was formed of tin oxide particles on the surface of one of the FTO glass substrates. A driving voltage was applied such that the electrode on which the porous film had not been formed was the positive side and such that the electrode on which the porous film had been formed was the negative side. The compound 1 which was converted from a neutral state into a cationic species through an oxidation reaction was colored at the positive electrode on which the porous film had not been formed.

Applying a driving voltage of 2 V between the electrodes caused oxidation of the compound 1 at the positive electrode and then resulted in coloring thereof.

A driving power source applied a fixed voltage which induced an electrochemical reaction. Connection of an organic EC device with the driving power source was controlled by a switching circuit (relay circuit) that was a resistor-switching unit, and the switching circuit changed interconnection of the driving power source with the EC device to a connected state or a disconnected state. The timing of the control by the switching circuit was determined by supplying a voltage from a device for generating an arbitrary waveform. The device for generating an arbitrary waveform can be deemed as part of a controller. The operation of the switching circuit was the same as connecting a resistor having a low resistance or a resistor having a high resistance in series to the wiring of the organic EC device. In this case, the resistor having a low resistance can be regarded as a resistor of a wiring material, and the resistance thereof was not more than 10Ω. The resistor having a high resistance was air, and the resistance thereof therefore greatly exceeded 1 MΩ. The drive frequency was 100 Hz.

The device circuit was subjected to the switching of low resistance and high resistance in this way to control the amount of electric current flowing through the circuit. In the case where the resistor having a low resistance was connected to the circuit, electric current flowed to cause an oxidation reaction and the resulting coloring. In the case where the resistor having a high resistance was connected to the circuit, electric current did not flow, and thus an oxidation reaction was not caused. In this case, the organic EC material underwent self-discoloring as a result of diffusion thereof. Absorbance transiently changed until the degree of the oxidation reaction and the degree of the self-discoloring reached a good balance therebetween; after the balance was established, the absorbance was maintained.

The change in absorbance was measured with a spectroscopy system (USB2000+ manufactured by Ocean Optics, Inc.) which can measure absorption in ultraviolet, visible, and near infrared regions. The magnitude of absorbance hereafter refers to the absorbance at a single wavelength corresponding to any of absorption peaks which the organic EC device showed unless otherwise specified. FIG. 8 illustrates a change in absorbance at an absorption peak of 600 nm which the compound 1 showed.

In the case where the application of a driving voltage and the control of a fixed Duty ratio were simultaneously carried out in the organic EC device in the initial state that was a colorless state, the eventual absorbance in the organic EC device was changed in response to a change in the Duty ratio. Light transmittance was able to be controlled by adjusting a Duty ratio in this way. The larger the Duty ratio was, the more greatly absorbance changed.

FIG. 9 illustrates the relationship between absorbance and a driving time at an absorption peak of 600 nm which the compound 1 showed in a discoloring direction in the case where a Duty ratio was decreased under application of a driving voltage of 2.0 V after the organic EC device was saturated in a coloring direction.

In the organic EC device, the change in a Duty ratio resulted in a change in absorbance, and light transmittance was able to be controlled also in a discoloring direction by adjusting a Duty ratio. The smaller the Duty ratio was, the more greatly the absorbance changed.

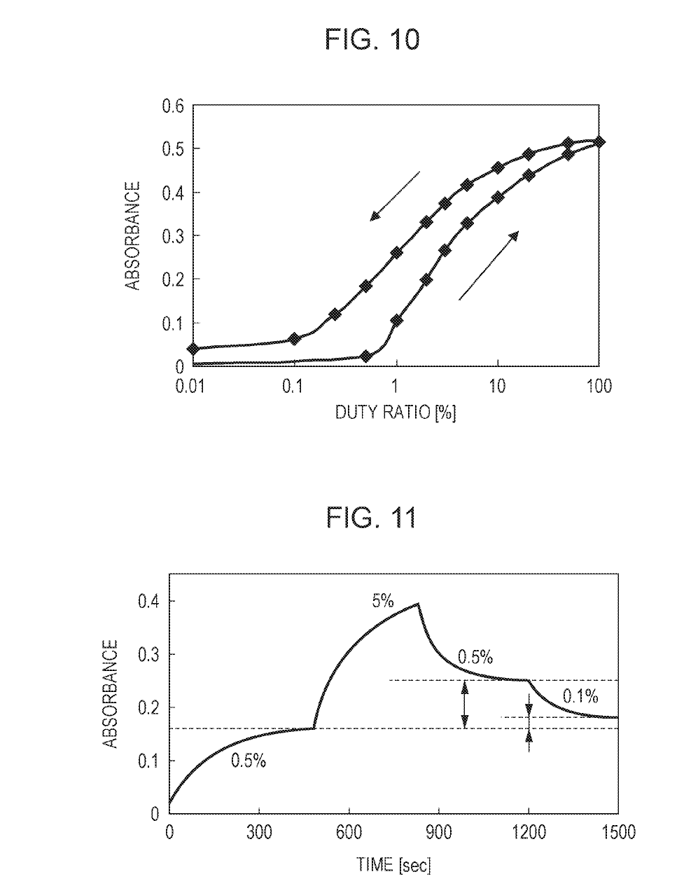

FIG. 10 illustrates the relationship between absorbance and a Duty ratio at an absorption peak of 600 nm in driving of the organic EC device in a coloring direction and in a discoloring direction. In FIG. 10, a sample was changed from the one used in FIGS. 8 and 9 even though the sample was made of the same materials and had the same device structure. The organic EC device was driven for two minutes at each Duty ratio under application of a voltage of 2.0 V, and then the resulting absorbance was plotted; the absorbance was in a state in which its change was substantially saturated after a transient state. In the driving, the application of voltage was continued from the initial state, and a Duty ratio was increased from approximately 0% to 100% and then decreased from 100% to approximately 0%.

As illustrated in FIG. 10, in the organic EC device, absorbance obtained at one Duty ratio in the coloring direction was different from absorbance obtained at the same Duty ratio in the discoloring direction; in other words, the organic EC device had hysteresis characteristics. A duty ratio to be employed to increase absorbance from a low level to the intended level needed to be different from a duty ratio to be employed to decrease absorbance from a high level to the same intended level. In FIG. 10, the absorbance plotted in the coloring direction is below the absorbance plotted in the discoloring direction. This means that the colored state was readily maintained in the organic EC device using at least the compound 1 and having the above-mentioned structure once it was established. The stability of the cation of the compound 1 had an effect on this phenomenon. In addition, if the cations are distributed so as not to contact the both electrodes in the cross-sectional direction of the device, the rate of the self-discoloring is small; hence, the distribution of the cations in the EC layer also had an effect.

In the organic EC device, changing absorbance in the coloring direction and in the discoloring direction at the same Duty ratio showed a hysteresis. The controller was therefore desirably equipped with at least two characteristic tables in the coloring direction and in the discoloring direction, respectively, and selected a characteristic table proper for a direction of a change in absorbance to perform control for the intended absorbance.

FIG. 11 illustrates a temporal change in absorbance per Duty ratio; in particular, in this example, a Duty ratio was controlled in consideration of a difference in a change in absorbance between the coloring direction and the discoloring direction at the same Duty ratio to compensate for the gap in absorbance.

Another organic EC device using the compound 1 was used as a sample, and absorbance at an absorption peak of 600 nm was employed.

A driving voltage of 1.8 V was applied at a Duty ratio of 0.5% from the colorless state of the organic EC device. Absorbance increased owing to coloring, passed through a transient state, and showed a saturation tendency at approximately 0.16. Then, increasing the Duty ratio to 5% led to an enhancement in absorbance to approximately 0.39. Then, decreasing the Duty ratio from 5% to 0.5% caused a decrease in the absorbance due to discoloring, and the absorbance passed through a transient state and showed a saturation tendency at approximately 0.25. In particular, in driving at a Duty ratio of 0.5%, the resulting absorbance in the case where the absorbance was increased at a Duty ratio of 0.5% in the coloring direction was different from the resulting absorbance in the case where the absorbance was decreased at the same Duty ratio in the discoloring direction.

Further decreasing the Duty ratio from 0.5% to 0.1% for the purpose of reducing the gap in absorbance led to a decrease in the absorbance to 0.18, which enabled the gap in absorbance to be reduced from 0.09 to 0.02. In this case, also in the case where the Duty ratio was directly decreased from 5% to 0.1%, the similar effect was able to be provided.

In driving of the organic EC device in which application and non-application of a fixed voltage were controlled by PWM and in which light transmittance was controlled on the basis of a proportion of time of application of voltage to a PWM pulse (Duty ratio), light transmittance was able to be precisely controlled both in a coloring direction and in a discoloring direction by selecting a Duty ratio for reducing a gap in absorbance in view of the difference in a characteristic between the coloring direction and the discoloring direction as described above.

### Comparative Example

An example in which a difference in the characteristic of the organic EC device between the coloring direction and the discoloring direction was not considered was the case in which the Duty ratio illustrated in FIG. 11 was changed to 0.5%, 5%, and 0.5% in sequence. In this case, hysteresis characteristics were not considered, and the magnitude of absorbance was assumed to be in one-to-one correlation with a Duty ratio.

As illustrated in FIG. 11, in the case where coloring was carried out at a Duty ratio of 0.5%, absorbance reached approximately 0.16. In the case where the absorbance was increased to a higher level of 0.39 at a Duty ratio of 5% and where the Duty ratio was then decrease to 0.5% to return the absorbance to 0.16 for discoloring, the absorbance did not reach 0.16 but showed a saturation tendency at approximately 0.25.

Since a Duty ratio was not selected on the basis of a hysteresis, a difference in absorbance was large; thus such a case was inadequate for precise control of light transmittance both in the coloring direction and in the discoloring direction.

### Example 2

In Example 2, in order to explain control of light transmittance, the anodic material employed in Example 1 was used in combination with a viologen material that is a cathodic material. Ethylviologen diperchlorate (EV2⁺(ClO₄⁻)₂) was used as a viologen material.

In the use of the anodic material and the cathodic material in combination, applying a driving voltage caused oxidation of the anodic material at the positive electrode and reduction of the cathodic material at the negative electrode, which resulted in coloring of these materials. Ethylviologen was in a colorless state when it was in the form of a stable dication and entered a colored state when it became a cation through one-electron reduction. When the electrodes were short-circuited to a voltage of 0 V after the coloring, the anodic material was reduced to return to a neutral state with the result that it entered the colorless state, and the cathodic material was oxidized to return to a dication with the result that it entered the colorless state.

An organic EC device in which both the anodic material and the cathodic material were used in this way had an excellent reactivity owing to the active materials at the two electrodes and therefore was able to be driven at higher speed; hence, a transient response time to a change in a Duty ratio was shorter in Example 2 than in Example 1.

Using an anodic material and a cathodic material in combination or using anodic materials and cathodic materials in combination enabled more flexible color design.

In the organic EC device, a solution in which the compound 1, the ethylviologen, and a supporting electrolyte (TBAP) had been dissolved in a solvent of propylene carbonate was used. The concentration of each of the compound 1 and ethylviologen was 10 mM, and the concentration of TBAP was 0.1 M. The organic EC device included two FTO glass substrates attached to each other with a 125-μm thick spacer interposed therebetween, and the solution was confined in a space defined by the substrates and the spacer.

Applying a driving voltage of 1.5 V between the two electrodes caused oxidation of the compound 1 at the positive electrode and reduction of the ethylviologen at the negative electrode, which resulted in coloring of these materials.

FIG. 12 illustrates the relationship between absorbance and a Duty ratio at an absorption peak of 600 nm in driving of the organic EC device in a coloring direction and in a discoloring direction. The measurement environment was the same as in Example 1; the frequency was 100 Hz, and the driving voltage was 1.5 V.

As illustrated in FIG. 12, also in the organic EC device of Example 2, absorbance obtained at one Duty ratio in the coloring direction was different from absorbance obtained at the same Duty ratio in the discoloring direction.

In such an organic EC device, as compared with the EC device of Example 1, hysteresis characteristics were smaller, and a Duty ratio was able to be controlled within a narrower range. This was because the organic EC device using both the anodic material and the cathodic material had an excellent reactivity. The hysteresis was larger in a region in which the Duty ratio was small. This is because the materials were distributed so as not to contact the electrodes and thus a discoloring rate was small.

In the organic EC device, changing absorbance in the coloring direction and in the discoloring direction at the same Duty ratio showed a hysteresis. The controller was therefore desirably equipped with at least two characteristic tables in the coloring direction and in the discoloring direction, respectively, and selected a characteristic table proper for a direction of a change in absorbance to perform control for the intended absorbance.

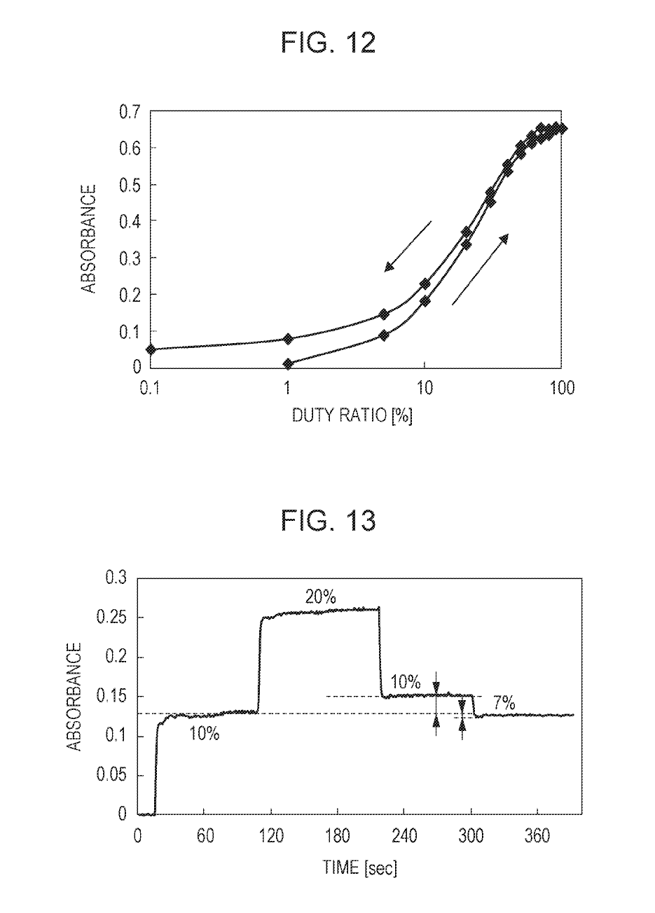

FIG. 13 illustrates a temporal change in absorbance per Duty ratio; in particular, in this example, a Duty ratio was controlled in consideration of a difference in a change in absorbance between the coloring direction and the discoloring direction at the same Duty ratio to compensate for the gap in absorbance.

Another organic EC device using the compound 1 and the ethylviologen was used as a sample, and absorbance at an absorption peak of 600 nm was employed.

A driving voltage of 1.5 V was applied at a Duty ratio of 10% from the colorless state of the organic EC device. Absorbance increased owing to coloring, passed through a transient state, and showed a saturation tendency at approximately 0.13. Then, increasing the Duty ratio to 20% led to an enhancement in absorbance to approximately 0.26. Then, decreasing the Duty ratio from 20% to 10% caused a decrease in the absorbance due to discoloring, and the absorbance passed through a transient state and showed a saturation tendency at approximately 0.15. In particular, in driving at a Duty ratio of 10%, the resulting absorbance in the case where the absorbance was increased at a Duty ratio of 10% in the coloring direction was different from the resulting absorbance in the case where the absorbance was decreased at the same Duty ratio in the discoloring direction.

Further decreasing the Duty ratio from 10% to 7% for the purpose of reducing the gap in absorbance led to a decrease in the absorbance to 0.126, which enabled the gap in absorbance to be reduced from 0.02 to 0.004. In this case, also in the case where the Duty ratio was directly decreased from 20% to 7%, the similar effect was able to be provided.

In driving of the organic EC device in which application and non-application of a fixed voltage were controlled by PWM and in which light transmittance was controlled on the basis of a proportion of time of application of voltage to a PWM pulse (Duty ratio), light transmittance was able to be precisely controlled both in a coloring direction and in a discoloring direction by selecting a Duty ratio for reducing a gap in absorbance in view of the difference in a characteristic between the coloring direction and the discoloring direction as described above.

The present invention can provide a driving device for an electrochromic device, the driving device enabling a reduction in a variation in absorbance between the case in which the absorbance is increased and the case in which the absorbance is decreased; the present invention also provides an electrochromic apparatus, an optical filter, an imaging apparatus, a lens unit, a window member, and a method for driving an electrochromic device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-269688, filed Dec. 26, 2013, which is hereby incorporated by reference herein in its entirety.

1. A driving device for an electrochromic device which includes a pair of electrodes and an electrochromic layer disposed between the electrodes and containing an electrochromic material, the driving device comprising a controller which applies a driving voltage to the electrochromic device as a continuous driving pulse having one cycle including a period of application of the driving voltage and an intermission period and which controls the absorbance of the electrochromic device by adjusting a Duty ratio which is a proportion of the period of application of the driving voltage to the one cycle, the driving voltage being a voltage which causes at least any one of an oxidation reaction and reduction reaction of the electrochromic material, wherein
the electrochromic device has a characteristic region in which a change in the Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, and
the controller performs the control in which a Duty ratio employed in the case where the light transmittance of the electrochromic device is decreased to the intended light transmittance T₁ in the characteristic region is different from a Duty ratio employed in the case where the light transmittance of the electrochromic device is increased to the intended light transmittance T₁.

2. The driving device for an electrochromic device according to claim 1, wherein the controller adjusts the Duty ratio so that light transmittance resulting from decreasing the light transmittance of the electrochromic device for the intended light transmittance T₁ is equal to light transmittance resulting from increasing the light transmittance of the electrochromic device for the intended light transmittance T₁.

3. The driving device for an electrochromic device according to claim 1, wherein the controller performs the control in which the Duty ratio is determined on the basis of a preliminary defined relational expression that represents the relationship between the Duty ratio and absorbance.

4. The driving device for an electrochromic device according to claim 1, wherein the controller performs the control in which a Duty ratio employed for decreasing the light transmittance of the electrochromic device to the intended light transmittance T₁ is adjusted to be smaller than a Duty ratio employed for increasing the light transmittance of the electrochromic device to the intended light transmittance T₁.

5. The driving device for an electrochromic device according to claim 1, wherein the intermission period is a period in which a resistor R2 is connected in series to a closed circuit including the electrochromic device and a driving power source under application of the driving voltage, the resistor R2 having a higher resistance than a resistor R1 connected in the period of application of the driving voltage.

6. The driving device for an electrochromic device according to claim 5, wherein the resistor R2 is air.

7. An electrochromic apparatus comprising:
the driving device for an electrochromic device according to claim 1; and
an electrochromic device driven by the driving device.

8. The electrochromic apparatus according to claim 7, wherein the electrochromic device is an organic electrochromic device.

9. An optical filter comprising:
the driving device for an electrochromic device according to claim 1; and
an electrochromic device driven by the driving device.

10. The optical filter according to claim 9, wherein the electrochromic device is an organic electrochromic device.

11. The optical filter according to claim 10, wherein an electrochromic material of the organic electrochromic device contains a compound having an electrochromic moiety having a thiophene ring and two aromatic rings directly bonded to the electrochromic moiety, wherein
in each of the two aromatic rings, the atoms adjoining the atom bonded to the electrochromic moiety are substituted with any of an alkyl group, an alkoxy group, and an aryl group, and
in the electrochromic moiety, the atoms adjoining the atoms bonded to the two aromatic rings are substituted with any of an alkyl group, an alkoxy group, and an aryl group.

12. A lens unit comprising:
the optical filter according to claim 9; and
a plurality of lens groups.

13. An imaging apparatus comprising:
the lens unit according to claim 12; and
an imaging unit having a light-receiving device which receives light that has passed through the optical filter.

14. An imaging apparatus comprising:
the driving device for an electrochromic device according to claim 1;
an electrochromic device driven by the driving device;
a plurality of lens groups; and
a light-receiving device.

15. A window member comprising:
the driving device for an electrochromic device according to claim 1; and
an electrochromic device driven by the driving device.

16. A method for driving an electrochromic device which includes a pair of electrodes and an electrochromic layer disposed between the electrodes and containing an electrochromic material, the method comprising use of a controller which applies a driving voltage to the electrochromic device as a continuous driving pulse having one cycle including a period of application of the driving voltage and an intermission period and which controls the absorbance of the electrochromic device by adjusting a Duty ratio which is a proportion of the period of application of the driving voltage to the one cycle, the driving voltage being a voltage which causes at least any one of an oxidation reaction and reduction reaction of the electrochromic material, wherein
the electrochromic device has a characteristic region in which a change in the Duty ratio from a to b brings a change in the light transmittance of the electrochromic device from T_{A} to T_{B} and in which a change in the Duty ratio from b to a brings a change in the light transmittance of the electrochromic device from T_{C} different from T_{B} to T_{D} different from T_{A}, and
the controller controls the electrochromic device such that a Duty ratio employed in the case where the light transmittance of the electrochromic device is decreased to the intended light transmittance T₁ in the characteristic region is adjusted so as to be different from a Duty ratio employed in the case where the light transmittance of the electrochromic device is increased to the intended light transmittance T₁.

17. The method according to claim 16, wherein the Duty ratio is adjusted so that light transmittance resulting from decreasing the light transmittance of the electrochromic device for the intended light transmittance T₁ is equal to light transmittance resulting from increasing the light transmittance of the electrochromic device for the intended light transmittance T₁.

18. The method according to claim 16, wherein the Duty ratio is determined on the basis of a preliminary defined relational expression that represents the relationship between the Duty ratio and absorbance.

19. The method according to claim 16, wherein the controller performs the control in which a Duty ratio employed for decreasing the light transmittance of the electrochromic device to the intended light transmittance T₁ is adjusted to be smaller than a Duty ratio employed for increasing the light transmittance of the electrochromic device to the intended light transmittance T₁.
